(19) United States
(12) Patent Application Publication
(10) Pub. No.: US 2003/0039317 A1
(43) Pub. Date: Feb. 27, 2003

(54) Method and apparatus for constructing a sub-carrier map

(76) Inventors: Douglas Hamilton Taylor, Kanata (CA); Bradley Robert Lynch, Ottawa (CA)

Correspondence Address: OGILVY RENAULT, 1981 MCGILL COLLEGE AVENUE, SUITE 1600, MONTREAL, QC, H3A2Y3, CA

(21) Appl. No.: 09/932,945

(22) Filed: Aug. 21, 2001

(51) Int. Cl. H04L 27/04; H04L 27/12; H04L 27/20; H04M 11/04

(52) U.S. Cl. 375/295; 340/310.01

(57) ABSTRACT

A method and apparatus for selecting a modulation type and forward error correction (FEC) configuration and a sub-carrier map to maximize data throughput in a multi-carrier orthogonal frequency division multiplexing (OFDM) system for use in an inherently noisy network, such as power line distribution networks. A sub-carrier map or is constructed by selecting a sub-set of available sub-carriers using estimated sub-carrier SNR values and two predefined criteria, a SNR threshold and a useful sub-carrier ratio. The invention leverages the error correction capacity of FEC to maximize data throughput.

### CROSS-REFERENCE TO RELATED APPLICATIONS

This is the first application filed for the present invention.

### MICROFICHE APPENDIX

Not applicable.

### TECHNICAL FIELD

The present invention relates generally to the field of spread spectrum communications and more particularly, to carrier selection in a multi-carrier communications system for use on noisy network media such as power lines.

### BACKGROUND OF THE INVENTION

The use of spread spectrum techniques for data communications is well known. Specifically, it is well known in the art to use multi-carrier orthogonal frequency division multiplexing (OFDM) for power-line communications systems due to resilience to time-dispersive channels and narrow band interferers. In a power-line based, home networking environment, amateur radio transmissions, short wave broadcasts and other power line communications devices are examples of potential sources of such interference.

In a frequency selective channel and/or a colored noise environment some sub-carriers or tones in a multi-carrier modulation scheme may be noisy and experience low signal-to-noise ratio (SNR) values that will make them susceptible to errors. This results in poor fidelity of the received data and/or a significantly reduced throughput due to the necessity of re-transmitting lost packets.

Throughput under these circumstances can be improved by introducing forward error correction (FEC), selecting different modulation techniques and by avoiding noisy sub-carriers by selecting only acceptable sub-carriers. A range of different algorithms for selecting the appropriate sub-carriers and modulation modes have been proposed in the literature. Techniques known in the art include looking at the SNR values of individual sub-carriers and eliminating sub-carriers that have a bit-error rate (BER) below a specified threshold, prior to forward error correction (FEC) decoding. A possible problem with this technique is that the decoded BER is very sensitive to small changes in the BER prior to decoding. Therefore small errors in the SNR estimation may result in a sub-carrier map which has a high BER after decoding.

International patent application WO 01/41341, entitled “Enhanced Channel Estimation”, filed Dec. 6, 2000 by Intellon Corporation, discloses a method for identifying usable carriers for a particular modulation type and selecting, if possible, a modulation type. The method requires that a specific number of carriers have a phase noise above a specified threshold. The method computes an average amount by which the carriers exceed the threshold and then ensures that this average is above a certain margin threshold. A possible disadvantage of this method is that modulation types having useful data capacity are not considered for selection. Another possible disadvantage of this method is that it does not leverage the error correcting capabilities of FEC to maximize throughput.

There is, therefore, a need for a more effective method for selecting appropriate sub-carriers in a multi-carrier modulation system for use in a noisy environment, that leverages the inherent capacity of FEC to optimize throughput in an OFDM communications system.

### SUMMARY OF THE INVENTION

It is an object of the present invention to provide an efficient and robust method and apparatus for selecting appropriate sub-carriers in a multi-carrier modulation system for use in a noisy environment.

It is another object of the invention to provide a method for selecting sub-carriers in a multi-carrier modulation system to improve data throughput.

The present invention therefore provides a method of selecting a sub-set of available sub-carriers or tones in a multi-carrier modulation system for use in data transfer based on measured or estimated sub-carrier SNR values. The selected sub-set of sub-carriers is referred to as a sub-carrier map. The selection is performed based on two parameters for each available modulation/FEC configuration: a predetermined SNR threshold ₘ, and a predetermined sub-carrier ratio rₘ where the subscript m associates the parameter with a certain configuration. A sub-carrier map is computed for each available modulation/FEC configuration and the configuration is selected that provides the highest throughput.

The invention also provides power network interface (PNI) with a sub-carrier map selector that constructs sub-carrier map for each modulation/FEC configuration used by the PNI for data transfer over a power line network, such as a home power line network.

One advantage of the present invention is that it leverages the error correction capabilities of FEC to improve data throughput by utilizing more sub-carriers for data transfer.

A further advantage of the invention is that it provides flexibility by permitting the parameters ₘ and rₘ to be easily tunable for improved performance.

A further advantage is that using two thresholds provides for more flexibility than a simpler scheme such as only selecting sub-carriers with a SNR greater than a given threshold value.

Yet a further advantage of the present invention is that it is simpler than selecting sub-carriers based on a given BER prior to FEC decoding.

### BRIEF DESCRIPTION OF THE DRAWINGS

Further features and advantages of the present invention will become apparent from the following detailed description, taken in combination with the appended drawings, in which:

FIG. 1 is a schematic diagram showing a home power line network for interconnecting multiple type devices, each of which uses a power network interface (PNI) that contains a sub-carrier map selector in accordance with one embodiment of the invention;

FIG. 2 is a simplified block diagram of a power network interface (PNI) showing a sub-carrier map selector and its associated input and output parameters in accordance with one embodiment of the invention;

FIG. 3 is a simplified block diagram of a sub-carrier map selector in isolation and its associated input and output parameters in accordance with one embodiment of the invention; and

FIG. 4 is a flowchart illustrating steps for selecting a modulation/FEC configuration and sub-carrier map in accordance with one embodiment of the invention.

It will be noted that throughout the appended drawings, like features are identified by like reference numerals.

### DETAILED DESCRIPTION OF THE PREFERRED EMBODIMENT

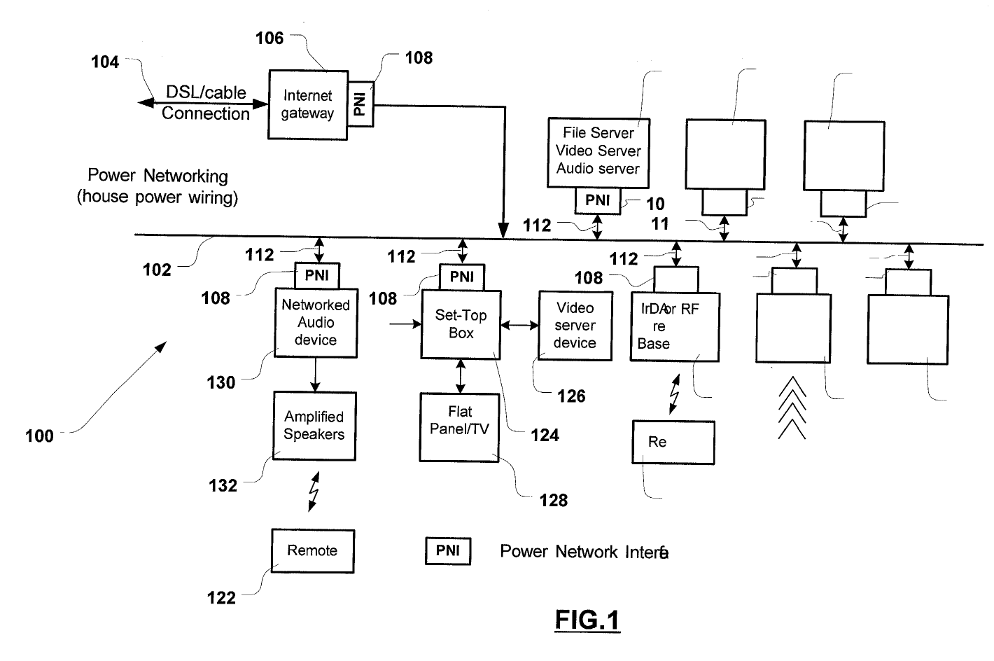

FIG. 1 shows a home power line network 100 used for interconnecting different types of devices, each of which uses a power network interface (PNI) 108 that is coupled to the network 100 via a connection 112. The receiver of the PNI 108 is adapted to construct sub-carrier maps and perform modulation configuration selection.

The home power line network 100 may include, for example, data-processing devices such as one or more personal computers (PC) 116; a file, video or audio server 110; kitchen net appliance 114; networked audio device 130 that is connected to amplified speakers 132 that can be controlled by a remote control unit 122; an infrared or a radio frequency base-station 120 that can be controlled by the remote control unit 122, a voice interface module 118 with a voice recognition system; and a set-top box 124 that is connected to a flat panel/TV 128 and also to a video server device 126. The home power line network 100 has access to the internet via an internet gateway 106 that is connected to the internet via a DSL or a cable connection 104.

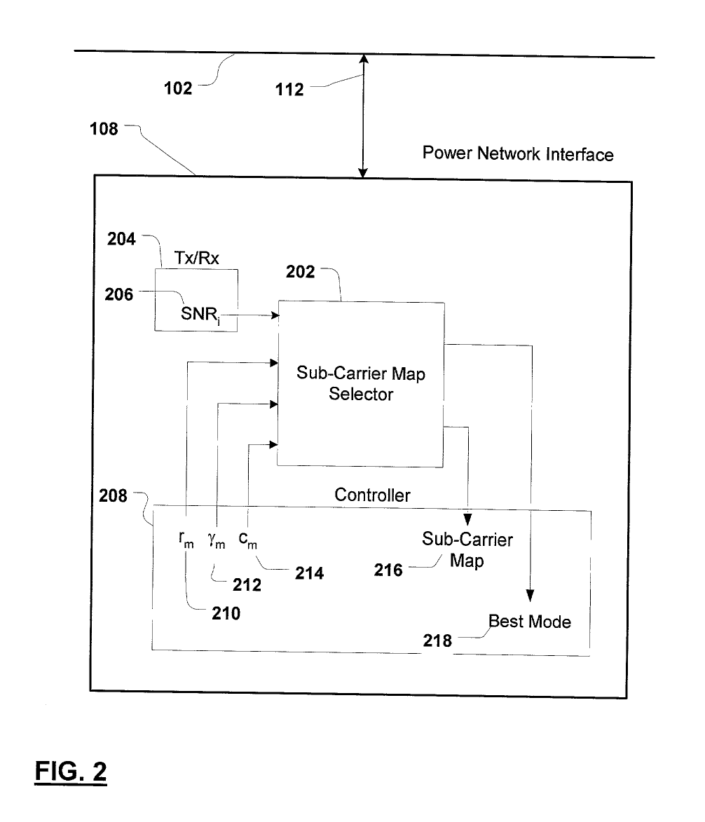

FIG. 2 shows a simplified block diagram of a power network interface (PNI) 108, coupled to the network 100 via connection 112, showing a sub-carrier map selector 202 in accordance with one embodiment of the invention. The sub-carrier map selector 202 is controlled by controller 208 which is typically incorporated in the power network interface. The sub-carrier map selector 202 receives signal-to-noise ratio (SNR) values, SNRᵢ 206 for each sub-carrier i from a transmitter/receiver 204. In one embodiment of the invention, the SNRᵢ 206 is estimated by first obtaining a noise estimate by measuring received power at each sub-carrier i when the respective sub-carrier is not carrying data. Signal power is then computed by subtracting the noise power from a received power at sub-carrier i when the respective sub-carrier is carrying data. SNRᵢ is then computed by dividing the signal power by the noise power. Other methods of estimating a SNR for each sub-carrier are also known and can be used with success.

The PNI supports several modulation/FEC configurations. Examples of modulation techniques include differential binary phase shift keying (DBPSK) and differential quadrature phase shift keying (DQPSK). For each supported configuration m, a SNR threshold ₘ 212 and a sub-carrier ratio rₘ 210 are selected for use by the sub-carrier map selector 202. The SNR threshold ₘ 212 is represented in decibels and sub-carrier ratio rₘ 210 is represented as a decimal fraction. These parameters are conveniently established using data derived through simulation, so that the bit error rate (BER) after FEC decoding is at an acceptable level.

Another parameter used by the sub-carrier map selector 202 is cₘ 214, which represents the data capacity of each sub-carrier for each modulation/FEC configuration m. Cₘ is primarily a function of the number of bits per symbol for continuation of the modulation type and the forward error correction algorithm used in the configuration.

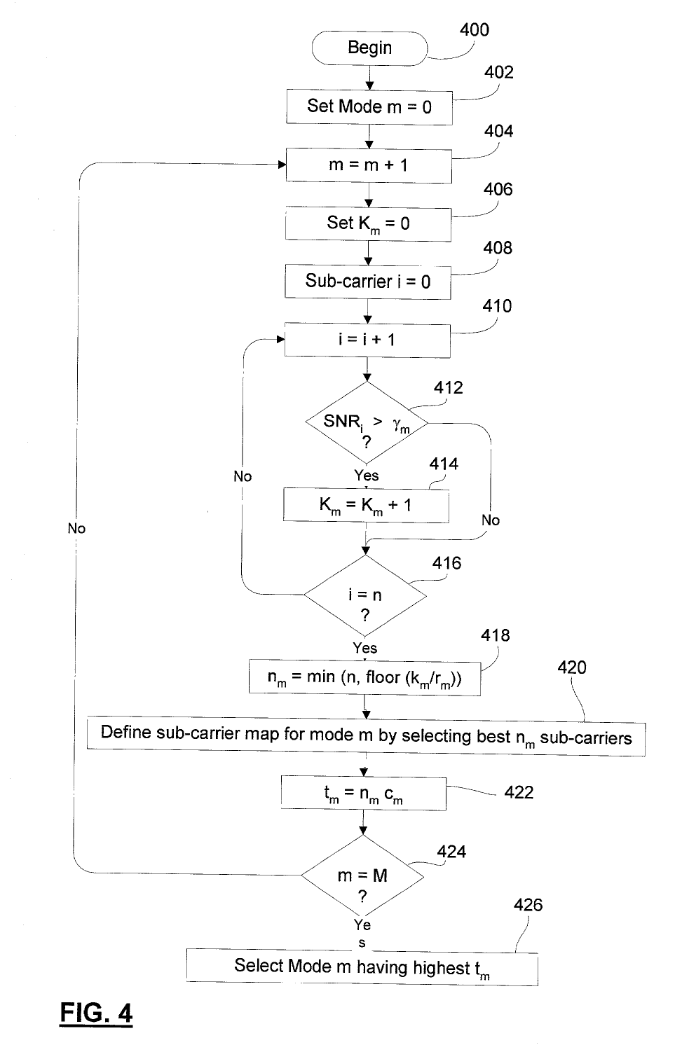

The sub-carrier map selector 202 uses the input parameters ₘ, rₘ and cₘ to construct a sub-carrier map 216 for each configuration m. The sub-carriers for use in data transmission are selected so that the predetermined ratio rₘ 210 of the selected sub-carriers have a SNR greater than ₘ 212. The sub-carrier map selector 202 then selects the best mode 218 representing the modulation/FEC configuration m 218 having the highest throughput. The algorithm for selecting the best modulation/FEC configuration using the sub-carrier map will be further described below with reference to FIG. 4.

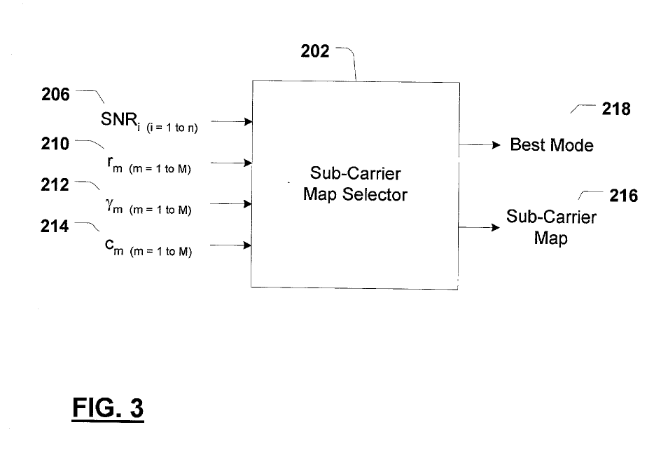

FIG. 3 is a schematic diagram of the sub-carrier map selector 202 and associated input and output parameters. As explained above, the input parameters include:

SNRᵢ, where i=1, 2, . . . , n; and n equals the number of sub-carriers and SNRᵢ is the estimate of signal-to-noise ratio of sub-carrier i;

rₘ, where m=1, 2, . . . , m; and m equals the number of modulation/FEC configurations (modes), and r is the ratio of sub-carriers having a SNRᵢ>ₘ;

ₘ, where is the SNR threshold for modulation/FEC configuration m; and

cₘ, where c is the transfer capacity of the modulation/FEC configuration m.

These input parameters are used, as explained below, to generate a sub-carrier map 216 for each modulation/FEC configuration. The sub-carrier maps 216 are then used to select a best one of the modulation/FEC configurations (best mode 218).

FIG. 4 is a flowchart representing an exemplary embodiment of the method in accordance with the present invention for constructing the sub-carrier maps for each modulation and FEC configuration, and using the sub-carrier maps to select the best modulation/FEC configuration. Before the process is begun, a SNR estimate SNRᵢ is computed for each of the sub-carriers (m). As explained above, the SNR threshold ₘ and sub-carrier ratio rₘ for each mode m is predetermined empirically through measurement or simulation so that the bit error rate (BER) after FEC decoding is at an acceptable level. The data capacity cₘ in bits per second per sub-carrier for each modulation/FEC configuration m is also known.

The method begins by initializing a mode counter m at step 402. The mode counter m is incremented at step 404 for each mode m. A counter kₘ, for counting sub-carriers with a SNR greater than the threshold ₘ, is initialized at step 406, and a sub-carrier counter i is initialized at step 408. The sub-carrier counter i is incremented at step 410. At step 412, the SNRᵢ for each sub-carrier i is compared to the threshold ₘ for mode m. If SNRᵢ is above ₘ, then kₘ is incremented at step 414. Steps 412 and 414 are repeated for each of the sub-carriers. A final value of kₘ after step 416 then represents the number of sub-carriers with a SNR greater than the threshold ₘ. Since the sub-carrier ratio rₘ implies that a certain number of sub-carriers can have a SNRᵢ below the threshold ₘ and still be useful if the inherent error correction capacity of FEC is leveraged, step 418 calculates the number of useful sub-carriers nₘ by dividing the number of sub-carriers with a SNR greater than the threshold ₘ by the sub-carrier ratio rₘ. More specifically, the method uses the equation:

nₘ=min(n, floor(kₘ/rₘ)). EQ (1)

Equation (1) ensures that an integer value no greater than the maximum number n of available sub-carriers is derived. At step 420, the sub-carrier map for mode m is constructed by selecting nₘ number of sub-carriers having the largest SNRᵢ. At step 422, the throughput tₘ for mode m is computed using the equation:

tₘ=nₘcₘ. EQ (2)

After the throughput for the current mode 6 is computed, the value of m is compared with a predefined value M, which equals the total number of modulation/FEC configurations to be evaluated (step 424). When m=M, the calculations have been performed for each mode m. At step 426, the throughputs tₘ for each mode m are compared, and the mode having the highest throughput is selected as being the best mode. The selected mode and the sub-carrier map associated with this mode can then be used by the transmission system.

As an example, if there are 76 sub-carriers (n=76), and one of the modes has 52 sub-carriers having a SNRᵢ above the threshold ₘ (kₘ=52) and a specified sub-carrier ratio rₘ=0.8, then nₘ=min(76, floor(52/0.8))=65. The sub-carrier map for that mode therefore consists of the 65 sub-carriers having the highest SNR. That is, the 52 sub-carriers that were determined to be above the threshold, plus an additional 13 of the remaining 24 sub-carriers with the highest SNR. As will be understood by those skilled in the art, one of the modulation/FEC configurations may be a robust transmission mode designed to ensure communication under the poorest channel conditions (albeit with a low throughput). Such a robust mode is commonly achieved by using a FEC scheme with high redundancy and/or by transmitting multiple copies of each data symbol. If conditions on a majority of the sub-carriers are particularly noisy, this robust transmission mode will be selected as the modulation/FEC configuration having the highest throughput, however, fail-over to this mode only occurs when the poorest channel conditions exist.

The method and apparatus in accordance with the invention therefore leverages the error correction capabilities of FEC to permit data transmission over some sub-carriers even if those sub-carriers are subject to a certain level of error-inducing noise. Data throughput is thereby improved and robust transmission mode is only selected when absolutely necessary.

The embodiment(s) of the invention described above is(are) intended to be exemplary only. The scope of the invention is therefore intended to be limited solely by the scope of the appended claims.

We claim:

1. A method for selecting a modulation configuration in a multi-carrier modulation system that supports a plurality of modulation configurations, comprising steps of:
for each modulation configuration m, determining a number of sub-carriers kₘ having a signal-to-noise ratio above a predefined threshold ₘ; computing a number of useful sub-carriers nₘ by dividing kₘ by a predefined ratio rₘ; constructing a sub-set of sub-carriers by selecting nₘ sub-carriers having the highest signal-to-noise ratio; and, computing a throughput tₘ, by multiplying nₘ by a predefined capacity cₘ per sub-carrier; and
selecting the modulation configuration having the highest throughput.

2. A method as claimed in claim 1, wherein the step of computing a number of useful sub-carriers further comprises a step of ensuring that the number of useful sub-carriers is an integer value not greater than n.

3. A method as claimed in claim 2 wherein the step of ensuring is performed using the equation:
nₘ=min(n, floor(kₘ/rₘ)).

4. A method as claimed in claim 1, wherein the predefined threshold ₘ is selected using empirical data derived from simulation results.

5. A method as claimed in claim 1, wherein the predefined ratio rₘ is selected using empirical data derived from simulation results.

6. A method as claimed in claim 5 wherein the ratio rₘ is selected to leverage the corrective power of forward error correction associated with the modulation configuration.

7. An apparatus for selecting a modulation configuration, in a multi-carrier modulation system that supports a plurality of modulation configurations, comprising:
means for determining a number of sub-carriers kₘ having a signal-to-noise ratio above a predefined threshold ₘ, for each modulation configuration m;
means for computing a number of useful sub-carriers nₘ for each modulation configuration m, by dividing kₘ by a predefined ratio rₘ;
means for constructing a sub-set of sub-carriers by selecting nₘ sub-carriers having the highest signal-to-noise ratio for each modulation configuration m;
means for computing a throughput tₘ, for each modulation configuration m, by multiplying nₘ by a predefined capacity cₘ per sub-carrier; and
means for selecting the modulation configuration having the highest throughput.

8. An apparatus as claimed in claim 7, wherein the means for computing a number of useful sub-carriers further comprises means for ensuring that the number of useful sub-carriers is an integer value not greater than n.

9. A method for selecting sub-carriers in a modulation system, comprising steps of:
selecting a first sub-set of sub-carriers k having a signal-to-noise ratio that exceeds a predetermined threshold;
dividing k by a predetermined ratio r to derive a number of sub-carriers to include in a second, larger sub-set of sub-carriers;
selecting the second sub-set of sub-carriers by selecting n sub-carriers having a highest signal-to-noise ratio; and
using the n sub-carriers for data transmission in the modulation system, whereby the predetermined ratio r is selected to leverage the corrective capacity of a forward error correction used in the modulation system to improve data throughput.

10. A method as claimed in claim 9 wherein the modulation system is a multi-carrier modulation system that supports a plurality m of modulation configurations, and the method further comprises steps of:
performing the steps of selecting the first sub-set, dividing and selecting the second sub-set for each of the modulation configurations m;
computing a throughput tₘ, for each modulation configuration m, by multiplying nₘ by a predefined capacity cₘ per sub-carrier of each second sub-set of sub-carriers; and
using the modulation configuration having the highest throughput.

11. A power network interface (PNI) for connecting an electronic device to a power line network, comprising:
a sub-carrier map selector adapted to receive a signal-to-noise ratio (SNRᵢ) for each of a plurality of sub-carriers i, i=1,2, . . . , n; to select a first sub-set of sub-carriers k; and, to divide k by a predetermined ratio r to derive a second, larger sub-set n of sub-carriers for use by the PNI for the transfer of data over the power line network, whereby r is selected to leverage the corrective capacity of forward error correction associated with a modulation configuration used by the PNI to transmit data over the power line network.

12. A power network interface as claimed in claim 11 wherein the sub-carrier map selector is further adapted to derive the second, larger sub-set n of sub-carriers for each of a plurality of modulation configurations m that may be used by the PNI to transfer data over the power line network.

13. A power network interface as claimed in claim 11 wherein the sub-carrier map selector is further adapted to compute a throughput tₘ, for each of the modulation configurations m, by multiplying nₘ by a predefined capacity cₘ per sub-carrier of each second sub-set of sub-carriers n.

14. A power network interface as claimed in claim 13 wherein the sub-carrier map selector is further adapted to select one of the modulation configurations m having a highest throughput tₘ for use by the PNI for the transfer of data over the power line network.

15. A power network interface as claimed in claim 11 wherein the power line network is a home power line network.
